(19) United States
(12) Patent Application Publication
(10) Pub. No.: US 2004/0064996 A1
(43) Pub. Date: Apr. 8, 2004

(54) Fish holder spring clamp system

(76) Inventor: Nicholas P. Armenti, East Orlean, MA (US)

Correspondence Address: MELVIN K. SILVERMAN, 500 WEST CYPRESS CREEK ROAD, SUITE 500, FT. LAUDERDALE, FL, 33309, US

(21) Appl. No.: 10/680,064

(22) Filed: Oct. 6, 2003

Related U.S. Application Data
(60) Provisional application No. 60/415,964, filed on Oct. 7, 2002.

(51) Int. Cl. A01K 71/00

(52) U.S. Cl. 43/7

(57) ABSTRACT

A fish holder clamp system includes an elongate lever having a handle end and a jaw end. Disposed intermediately between a proximal part of the handle end and a distal part of the jaw end is a pivot pin that defines an obtuse angle between virtual lines connecting the proximal part of the lever to the pivot pin and the distal part of the jaw end to the pivot pin. A lever effect about the pivot pin to causes an elevation of the jaw end responsive to a depression of the handle end.

### BACKGROUND OF THE INVENTION

The present invention relates to a fish holder spring clamp system and, more particularly, to a system that may be incorporated into the handle of a fish landing net.

It is commonplace for fishermen to keep a fish, which they have caught, for a given period of time before deciding whether or not to return the fish to the river or lake from which it has been obtained. It is, however, difficult to find a convenient manner in which to hold, store, or otherwise keep the fish during this “holding period.” Typically, fish such as trout or other fresh water fish, are caught with hand-held landing net after it has been hooked. Further, a similar need exists for purposes of removal of a hook, fly or lure from the mouth of the fish after it has been caught by hook and then landed with the landing net. In addition to the need for such improved means of fish holding after the landing process, a related need exists for the protection of the fish from injury during the hook removal process since, as is well known, a fish which is caught will not readily stay still, thereby increasing the difficulty of the hook removal process, and making it more difficult to hold the fish for later return to the water if that is the intent of the fisherman.

The present invention also addresses a need for an assembly that can be used to retrofit the handle of a landing net on an “as needed” basis.

Components in the nature of a spring clamp may be found in the prior art as, for example, is reflected in U.S. Pat. No. 4,813,107 (1989) to Cetrone, entitled Spring Clamp. However, the application thereof in the area of fishing has not been suggested in the prior art.

### SUMMARY OF THE INVENTION

A fish holder spring clamp system, adapted for integration into the handle of a hand-held fish landing net, includes an assembly for selectable connection thereto. The inventive fish holder spring clamp includes an elongate lever member having a handle end and a jaw end and, disposed intermediately between a proximal end of said handle end and a distal end of said jaw end, a pivot pin such that an obtuse angle is formed between virtual lines connecting said proximal end of said lever to said pivot pin and said distal end of said jaw end to said pivot pin. A lever effect is defined by the pivot pin thereby causing an elevation of said jaw end responsive to a depression of said handle end. Said pivot pin and its journal are formed integrally upon a longitudinal base member which is substantially co-linear with said lever. In a preferred embodiment, said longitudinal base member may be complementally secured within an elongate coupling of substantially like dimension. Therein, through the use of securement means, said base member and its complemental coupling may be secured to a handle of the landing net. Said distal end of said jaw end of said lever is provided with a grip plate wheel which is rotationally secured upon an axle of rotation which is formed at said distal end of the jaw end. Said lever is spring biased about said pivot pin into a closure position such that at least one surface of said grip plate wheel will, in the absence of an opposing force upon said handle end, urge the lever and, thereby, said grip plate wheel to a closed position relative to an opposing surface of said elongate base member to which said journal of said pivot pin is attached. Said handle end of the lever may be provided with a plurality of positioning means to control the extent of closure of the grip plate wheel relative to the mouth of a fish caught into which the wheel is inserted. Therefore, if said pivot pin is not sufficiently biased in the direction of the landing net, said positioning means are used to define the extent of rotation of the handle and jaw of the lever relative to the pivot pin.

It is accordingly an object of the present invention to provide a fish holder spring clamp system particularly for integration into the handle of a hand held-held fish landing net to provide for the securement of a caught fish at least during a period when a hook or lure lodged within the mouth of the fish is removed.

It is another object to provide a system of the above type to effect the protection of a fish from injury during the hook removal process.

It is a yet further object of the invention to provide a system of the above type which may be selectively secured to, or removed from, the handle of a fish landing net.

The above and yet other objects and advantages of the present invention will become apparent from the hereinafter set forth Brief Description of the Drawings and Detailed Description of the Invention.

### BRIEF DESCRIPTION OF THE DRAWINGS

FIG. 1 is a side perspective view of the inventive fish holder spring clamp system.

FIG. 2 is an operational view thereof showing the insertion of the grip plate wheel thereof into the mouth of a fish.

FIG. 3 is an exploded view of the base and coupling elements that are attached to the handle of the landing net.

FIG. 4 is a top plan view of the coupling member.

FIG. 5 is an end plan view thereof.

FIG. 6 is an end plan view of the elongate base member.

FIG. 7 is an assembly view showing the base member secured within the coupling member.

FIG. 8 is a schematic view of the distal end of the jaw of the lever member showing the securement of the grip plate wheel thereupon.

FIG. 9 is a perspective view of the surface of said jaw end which opposes the grip plate wheel including means for selectable rotational positioning of the grip wheel relative to said jaw end.

### DETAILED DESCRIPTION OF THE INVENTION

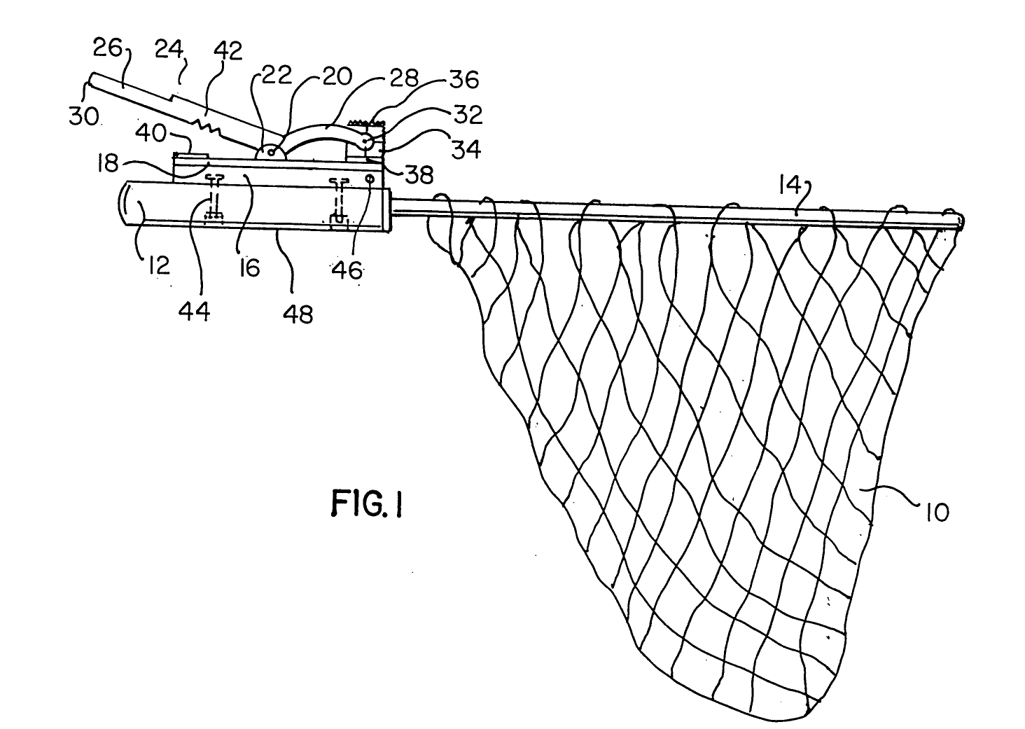

With reference to the perspective view of FIG. 1, there is shown a fish landing net 10, its handle 12, and net mouth defining means 14. Positioned above handle 12 is an elongate coupling member 16 and, complemental thereto, an elongate base member 18. Positioned transversely upon said base member 18 is a lever pin 20 within a lever pin journal 22 which is formed integrally with said base member 18.

Lever pin 20 serves as a pivot point for a lever 24 which includes a handle 26 and a jaw end 28. As may be noted, virtual lines connecting a proximal end 30 to pivot pin 20, on the one hand, and an axle 32 located at a distal end of said jaw end 28 to said pivot pin 20, creates an obtuse angle, that is, an angle of greater than 90 degrees but lesser than 180 degrees. Rotationally secured about said axle 32 at said distal end of jaw end 28 is a so-called grip plate wheel 34 having roughened or irregular surfaces 36, one of which normally rests against a gripping plate 38 which is secured to a distal area of elongate base member 18. At a proximal area of said base is a lever lock element 40 (more fully described below) which may be opened to lock with one of notches 42 provided on said handle 26 of lever member 24. Shown in phantom in FIG. 1 are bolts 44 and nuts 46 which are positioned within lower surface 48 of handle 12.

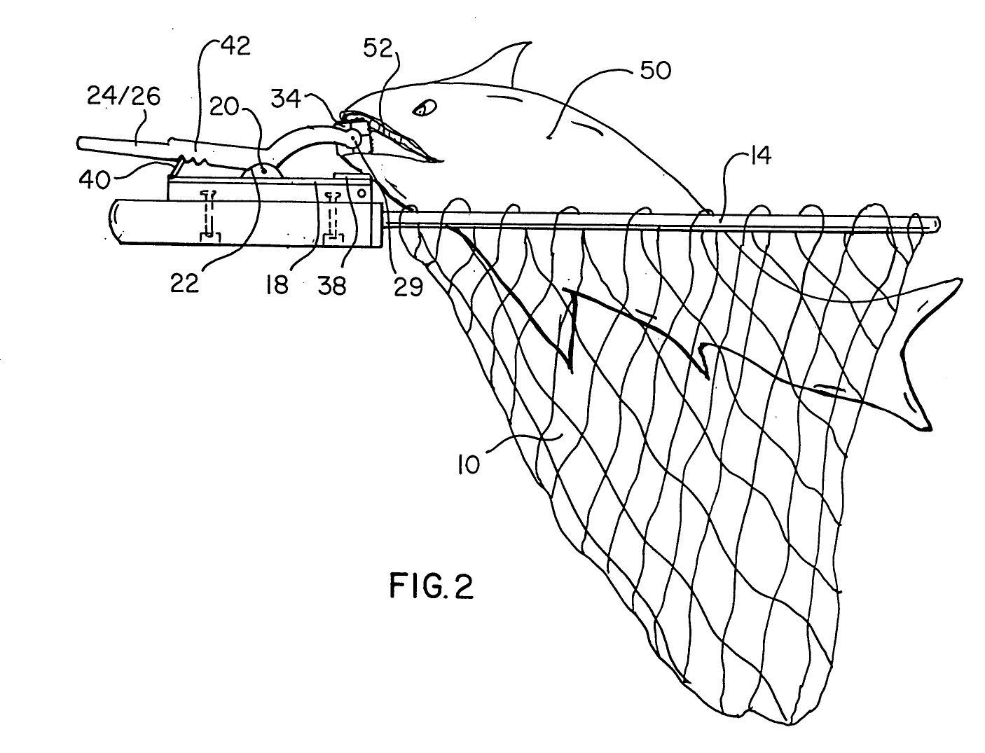

In FIG. 2 is shown an operational view of the structure of FIG. 1. More particularly, there is shown a fish 50, the mouth 52 of which has been placed upon said grip plate wheel 34, such that the jaw of the fish is held between said wheel and said surface 38 of base element 18. It should be appreciated that lever pin journal 22 includes a spring (not shown) having a normally clockwise bias such that the position of the lever 24 is normally that shown in FIG. 1.

However, it may be desirable to control the extent of rotation of the lever relative to pivot pin 20. In such instances, use is made of lock element 40 to position the same within one of notches 42 of handle 26 to thereby control the extent of rotation of the lever 24 relative to pin 20. Such adjustment is necessary to accommodate fish of different sizes or having mouths of different sizes.

As may be appreciated with reference to FIG. 3, a preferred embodiment of base member 18 and coupling 16 is that of longitudinally complemental elements in which a track 54 having, for example, a cross-sectional geometry of an inverted T, is provided which is complemental to a longitudinal bottom portion 56 of base member 18. Also shown in FIG. 3 are counter-sunk bolts 44A 44B and one of counter-sunk nuts 46 employed to secure the base member 18, coupling 16, and net handle 12 to each other.

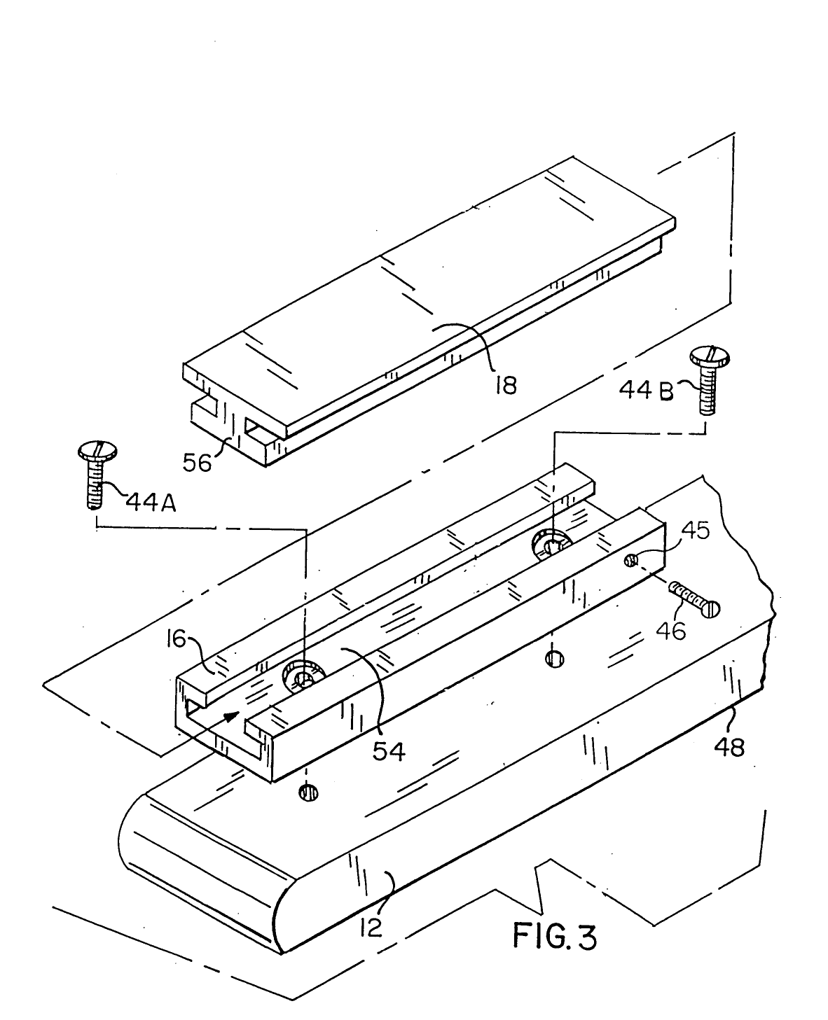

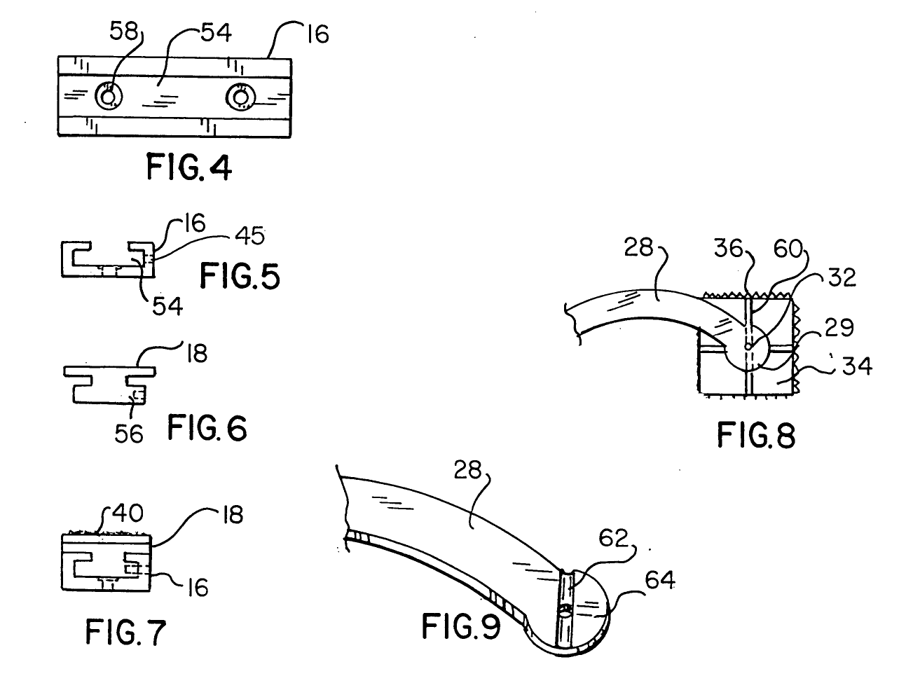

In the view of FIG. 4 is shown coupling 16, said inverted T geometry 54 and holes 58 which pass therethrough to accommodate said bolts 44. The same is shown in longitudinal end plan view in FIG. 5.

In FIG. 5, there is shown the distal end 28 of handle member 24 inclusive of axle 32 upon which is rotationally mounted grip plate wheel 34. As may be noted therein, there are provided a plurality of linear ridges 60 upon transverse surfaces of grip plate wheel which complementally engage linear channels 62 (see FIG. 9) located upon inner surface 64 of an end 29 of jaw 28 of the lever 24 (see FIGS. 1, 2 8 and 9).

Accordingly, in a preferred embodiment, distal end 29 of jaw 28 engages grip plate wheel 34 about both sides thereof, and rotation thereof into selectably different positions relative to jaw 28 is facilitated by rotation of grip wheel 34 relative thereto. This feature facilitates a positioning of the grip wheel into the fish mouth 52 and into a position that optimizes the securement therein.

FIG. 6 is a longitudinal end plan view of said base member 18 and its said bottom portion 56.

FIG. 7 is an end plan view of the assembly shown in FIG. 1 in which lever lock 40 is shown in its downward position.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention

I claim:

1. A fish holder clamp system comprising:
(a) an elongate lever having a handle end and a jaw end; and
(b) disposed intermediately between a proximal part of said handle end and a distal part of said jaw end, a pivot pin defining an obtuse angle between virtual lines connecting (i) said proximal part of said lever to said pivot pin and (iii) said distal part of said jaw end to said pivot pin,
whereby a lever effect about said pivot pin causes an elevation of said jaw end responsive to a depression of said handle end.

2. The system as recited in claim 1, comprising:
a longitudinal base member substantially co-linear with said lever, upon which said pivot pin and a journal thereof are integrally secured.

3. The system as recited in claim 2, comprising:
an elongate coupling complementally securable about said longitudinal base member.

4. The system as recited in claim 2, in which said distal part of said jaw end comprises:
a grip wheel rotationally secured upon an axle of rotation disposed at said distal part of said jaw end.

5. The system as recited in claim 4, comprising:
means for spring bias of said lever about said pivot pin into a closure position, in which at least one surface of said grip plate wheel, in the absence of an opposing force upon said handle end, urges said lever and, thereby, said grip wheel to a closed position relative to an opposing surface of said elongate base member to which said journal of said pivot pin is searched.

6. The system as recited in claim 5, in which said handle end of said lever, further comprises:
a plurality of positioning means for controlling an extent of closure of said grip wheel relative to a mouth of a fish therein.

7. The system as recited in claim 2, further comprising:
means for securement of said longitudinal base member to a handle of a hand-held landing net.

8. The system as recited in claim 7, comprising:
means for selectable attachment of said securement means.
